(19) United States
(12) Patent Application Publication
(10) Pub. No.: US 2003/0050067 A1
(43) Pub. Date: Mar. 13, 2003

(54) Wireless systems frequency reuse planning using simulated annealing

(76) Inventor: Jack Rozmaryn, Silver Spring, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/949,563

(22) Filed: Sep. 10, 2001

(51) Int. Cl. H04Q 7/20

(52) U.S. Cl. 455/447; 455/446

(57) ABSTRACT

An approach is provided for generating a frequency reuse plan for use in a radio communications system. A metric is calculated metric based upon an initial frequency reuse plan that specifies frequency assignments to a plurality of sectors. Each of the plurality of sectors is associated with a signal level value. The plurality of sectors are ordered based upon the corresponding signal level values. The frequency assignments are iteratively modifying to improve the metric according to the order of the plurality of sectors. The present invention has application to radio communications systems.

### FIELD OF THE INVENTION

The present invention relates to a radio communications system, and more particularly to access using a frequency reuse plan that optimizes system performance.

### BACKGROUND OF THE INVENTION

Wireless communications systems provide a convenient and flexible approach to deploying a voice and data infrastructure. With the advances in signal processing and communications technologies, the bandwidth and performance of such wireless systems rival that of terrestrial networks. Unlike terrestrial networks, wireless systems face the challenge of managing the usage of frequencies among a number of geographic regions (sometimes referred to as “cells”) that define coverage areas of the service providers. Because usable frequency spectra are finite, one approach has been to reuse the frequencies across the geographic regions.

Because the frequencies are reused, an important consideration in generating a frequency reuse plan is co-channel interference. Co-channel interference stems from the simultaneous transmissions on an identical channel. The existence of appreciable levels of co-channel interference translates into degradation, and even loss, of service for the subscribers. Traditionally, the frequency assignments within a coverage area are manually modified to minimize co-channel interference. Additionally, conventional “rules of thumb” have not yielded a frequency reuse plan with high system performance; that is, effective performance metrics are difficult to develop.

Therefore, there is a need for an approach to generating an optimal frequency reuse plan. There is also a need to minimize co-channel interference. There is a further need to develop metrics to provide improved system performance.

### SUMMARY OF THE INVENTION

These and other needs are addressed by the present invention in which a simulated annealing process is utilized to generate a wireless frequency reuse plan to minimize system co-channel interference. The simulated annealing process uses sequential optimization and incrementally improves the system signal-to-noise ratio (C/I) or any other equivalently valid performance metric. According to one embodiment of the present invention, the possible values of available frequencies are varied in each sector, whereby the resulting signal-to-noise ratios are calculated at each network location. A metric that is a function of each elemental C/I is calculated, and the assignment is temporarily made if the performance improves, and is discarded if the metric degrades.

According to one aspect of the present invention, a method is provided for generating a frequency reuse plan for use in a radio communications system. The method includes calculating a metric based upon an initial frequency reuse plan that specifies frequency assignments to a plurality of sectors. Each of the plurality of sectors is associated with a signal level value. The method also includes ordering the plurality of sectors based upon the corresponding signal level values. Further, the method includes iteratively modifying the frequency assignments to improve the metric according to the order of the plurality of sectors.

According to another aspect of the present invention, a computing system for generating a frequency reuse plan for use in a radio network is disclosed. The system includes means for calculating a metric based upon an initial frequency reuse plan that specifies frequency assignments to a plurality of sectors. Each of the plurality of sectors is associated with a signal level value. The system also includes means for ordering the plurality of sectors based upon the corresponding signal level values. Further, the system includes means for iteratively modifying the frequency assignments to improve the metric according to the order of the plurality of sectors.

According to another aspect of the present invention, a computer-readable medium carrying one or more sequences of one or more instructions for generating a frequency reuse plan for use in a radio communications system is disclosed. When executed by one or more processors, the instructions cause the one or more processors to perform the step of calculating a metric based upon an initial frequency reuse plan that specifies frequency assignments to a plurality of sectors. Each of the plurality of sectors is associated with a signal level value. Other steps include ordering the plurality of sectors based upon the corresponding signal level values; and iteratively modifying the frequency assignments to improve the metric according to the order of the plurality of sectors.

According to another aspect of the present invention, a signal for use in a radio communications system is disclosed. The signal has a frequency that is assigned according to a frequency reuse plan. The frequency reuse plan is generated based upon a simulated annealing process that includes calculating a metric based upon an initial frequency reuse plan that specifies frequency assignments to a plurality of sectors. Each of the plurality of sectors is associated with a signal level value. The simulated annealing process also includes ordering the plurality of sectors based upon the corresponding signal level values; and iteratively modifying the frequency assignments to improve the metric according to the order of the plurality of sectors.

According to another aspect of the present invention, a radio communications system is disclosed. The radio communications system includes a first terminal operating at a first frequency that is based upon a frequency reuse plan. Additionally, the system includes a second terminal operating at a second frequency that is based upon the frequency reuse plan. The frequency reuse plan is generated by calculating a metric based upon an initial frequency reuse plan that specifies frequency assignments that include the first frequency and the second frequency. The metric is optimized according to a simulated annealing process.

In yet another aspect of the present invention, a terminal is provided for communicating in a radio communications system. The terminal includes a transceiver that is configured to receive a signal having a predetermined frequency that is based upon a frequency reuse plan. The terminal also includes a modulator operating at the predetermined frequency. The frequency reuse plan is generated by calculating a metric based upon an initial frequency reuse plan that specifies frequency assignments that include the predetermined frequency. The metric is optimized according to a simulated annealing process.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a wireless communications system in which a simulated annealing approach for frequency reuse planning is employed, according to an embodiment of the present invention;

FIG. 2 is a diagram of a frequency plan utilizing 90° sectors with four frequency sets, according to an embodiment of the present invention;

FIGS. 3A and 3B is a flowchart of a simulated annealing approach for frequency reuse planning, according to an embodiment of the present invention; and

FIG. 4 is a diagram of a computer system that can be used to implement an embodiment of the present invention.

### DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the present invention is discussed with respect to the simulated annealing process, the present invention has applicability to other optimization techniques, such as genetic algorithms.

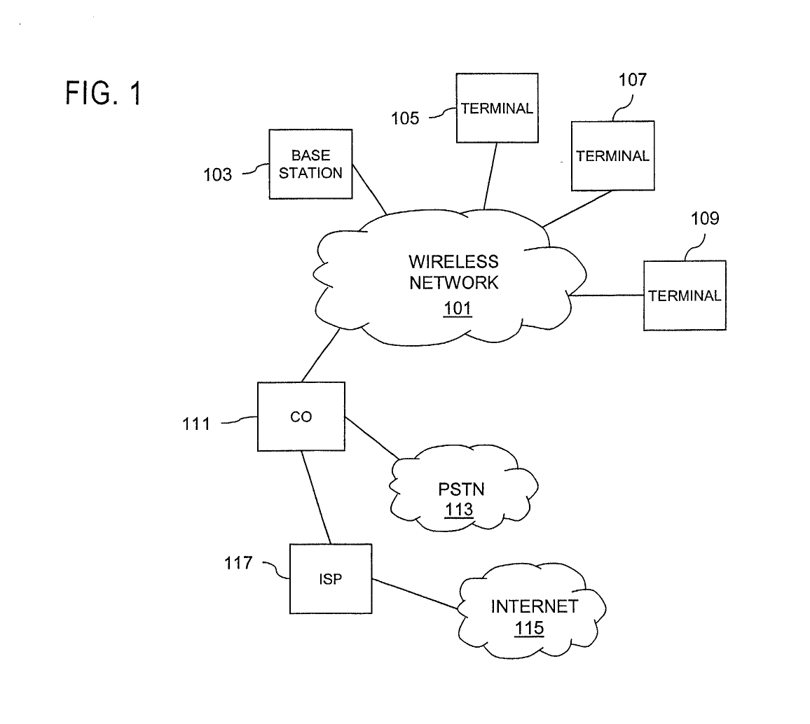

FIG. 1 shows a diagram of a wireless communications system in which a simulated annealing approach for frequency reuse planning is employed, according to an embodiment of the present invention. A wireless network 101, in an exemplary embodiment, is maintained by a service provider (e.g., cellular carrier); the network 101 includes a base station 103 that, among other functions, relays information from the radio terminals 105, 107, 109 to a central office (CO) 111. The CO 111 provides connectivity for the wireless network 101 to the public switched telephone network (PSTN) 113. Further, the central office (CO) 111 originates traffic from the PSTN 103 as well as the Internet 115, to which the CO 111 is connected via an Internet Service Provider (ISP) 117. It is noted that the wireless network 101 may be any type of radio communications system, such as a digital cellular network, a packet radio network, or a microwave network (e.g., point-to-multipoint (PmP) network).

In this example, it is assumed that the radio terminals 105, 107, 109 are within the coverage area of the network 101. The wireless network 101 follows a frequency reuse plan whereby co-channel interference among the terminals 105, 107, 109 is greatly minimized. The approach for generating the frequency reuse plan is described below.

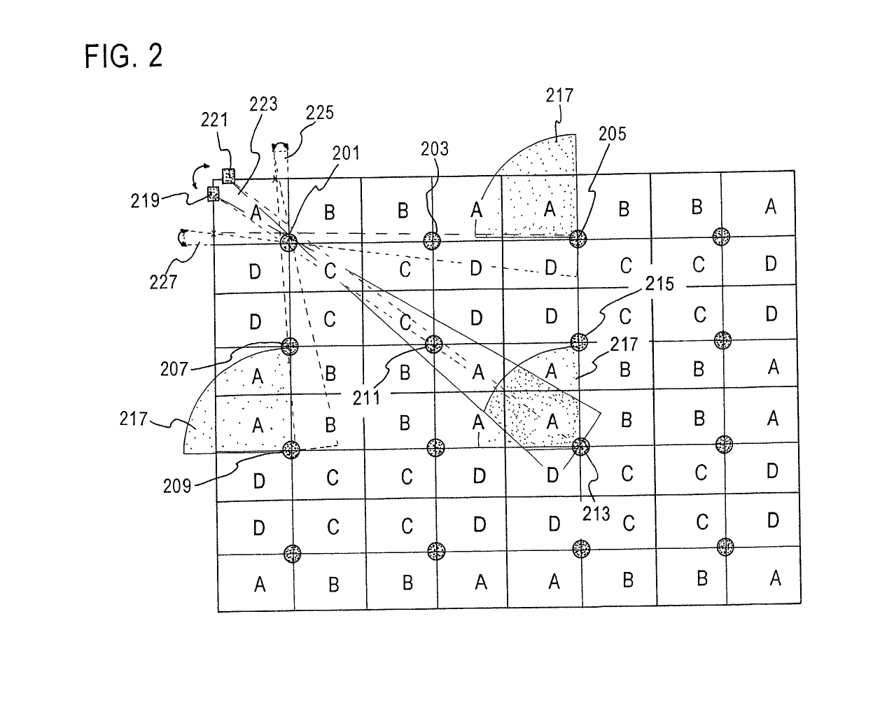

FIG. 2 is a diagram of a frequency plan utilizing 90° sectors with four frequency sets, according to an embodiment of the present invention. As previously discussed, in a spectrum limited environment, the available frequency channels are reused. The present invention provides the planning and optimization of such environments to minimize co-channel interference.

As shown, the large dots 201, 203, 205, 207, 209, 211, 213, 215 represent hub placements (i.e., location of the base station 103). The alphabetic labels “A”-“D” represent assigned frequency channels. Quarter-circle antenna patterns 217 are shown for two co-channel-aligned hubs (e.g., 209 and 207; and 213 and 215) with a 90° beamwidth. Two remote terminals 219, 221 are represented as squares in the upper left corner; the antenna patterns associated with these remote terminals 219, 221 are shown in alignment with the co-channel hubs (e.g., 213). These two remote terminal sites 219, 221, as a result, experience co-channel interference from the remote hub 213.

The amount of interference is a function of the distance to the serving hub 201 and to the interfering hubs 213. In this illustration, there is a 5-sector separation between the remote terminal(s) 219, 221 and the interfering hub 213. At the edge of coverage, the distance ratio of the desired hub 201 to the undesired hub 213 is 5 to 1. In an environment in which the propagation model attenuation falls off as the square of the distance, a distance ratio of 5 would yield a 14 dB pathloss attenuation and, therefore, a 14 dB C/I ratio. A C/I ratio of 14 dB may be sufficient for QPSK (Quadrature Phase Shift Keying) demodulation, but may not be sufficient for either 16 QAM (Quadrature Amplitude Modulation) or 64 QAM demodulation. Areas that may not support certain modulation schemes because of inadequate C/I ratios are referred to as potential “zones of limited modulation”; the notion of “potential” is attributable to the fact that any building or natural blockage to the interfering hub will eliminate the area as a limited modulation subscriber site. As the remote terminals 219, 221 approaches the serving hub, the distance ratio with the interfering hub increases, resulting in an increased C/I.

It is noted that if the alignment falls out of the beamwidth of the remote terminal either horizontally or vertically, or if the transmission angle lies beyond the nominal beamwidth of the interfering hub antenna, no interference occurs. This is true since the antenna attenuation pattern suppresses the undesired transmission signal. Accordingly, the only area that is a potential “zone of limited modulation” is the triangular area 223 bounded by the two remote terminals 219, 221 and the associated serving hub 201. Remote terminal locations beyond these two points do not align within the beamwidth of the remote terminal antenna and cause no interference. It is noted that the area of limited modulation decreases with a narrower subscriber antenna pattern. In addition to this interference zone, there are two other areas 225, 227 with the same limitations, as shown in FIG. 2.

As seen in the FIG. 2, only three dominant co-channel interferers in the underlying frequency reuse plan exist. All other co-channel transmitters are either in the sidelobes or backlobes of the hub antenna or the subscriber antenna. Therefore, they are “invisible” to the remote terminals 219, 221; the sidelobes are attenuated at least 40 dB based upon the antenna patterns that are discussed below. This reuse pattern is optimal, since the frequency reuse plan places the co-channel interfering hubs at a maximum distance before the pattern repeats.

For the purposes of explanation, it is assumed that the frequency reuse plan is deployed in a point-to-multipoint (PmP) environment. Co-channel interference in the millimeter wave PmP systems is dependent on the antenna performance and patterns of the hub and the remote terminal (RT). In particular, the individual patterns determine the amount of co-channel interference that is present.

The single most critical antenna pattern is the remote terminal antenna, as this pattern determines the locations of the potentially interfered subscribers. Additionally, the backlobe and the sidelobe performance of the antenna affects the magnitude of the interference. In an exemplary embodiment, the RT antenna nominal beamwidth at 24 GHz is less than 2°. The characteristics of the antenna of a remote terminal is specified below in Table 1:

TABLE 1

| | | |
|---|---|---|
| Minimum Pattern Mask: | | |
| | 5°-10° | 25 dB |
| | 10°-15° | 29 dB |
| | 15°-20° | 33 dB |
| | 20°-30° | 36 dB |
| | 30°-100° | 42 dB |
| | 100°-180° | 55 dB |
| Antenna Gain: | | |
| | 35-41 dBi | |

With respect to the hubs, three types of hub antennas with the following beamwidths may be utilized: 90°, 45°, and 22.5°, corresponding to 4-sectored hubs, 8-sectored hubs, and 16-sectored hubs, respectively. In an exemplary embodiment, each of the types of hub antennas operate at 24 GHz. Tables 2, 3, and 4 list the characteristics of the 90° hub antenna, 45° hub antenna, and 22.5° hub antenna, respectively.

TABLE 2

| | | |
|---|---|---|
| Pattern Mask: | | |
| | +135° [symbol] +180° | 35 dB |
| | −135° [symbol] −180° | 35 dB |
| Antenna Gain: | | |
| | 16 dBi | |

TABLE 3

| | | |
|---|---|---|
| Pattern Mask: | | |
| | +/−67° [symbol] +/−112° | 30 dB |
| | +/−112° [symbol] +/−180° | 35 dB |
| Antenna Gain: | | |
| | 19 dBi | |

TABLE 4

| | | |
|---|---|---|
| Pattern Mask: | | |
| | +/−33° [symbol] +/−56° | 30 dB |
| | +/−56° [symbol] +/−180° | 35 dB |
| Antenna Gain: | | |
| | 22 dBi | |

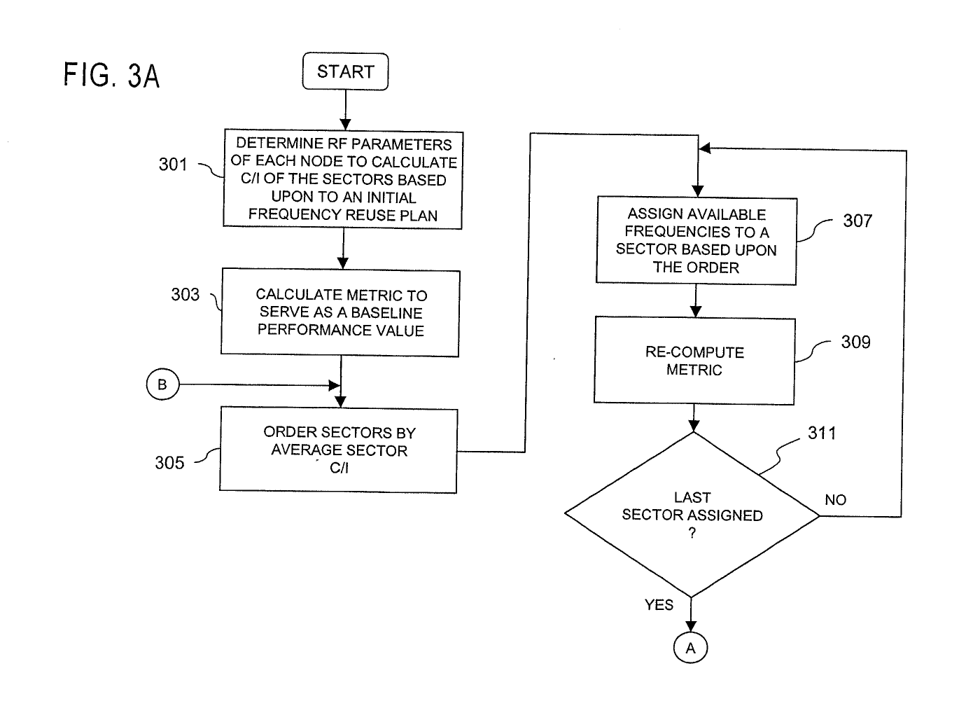

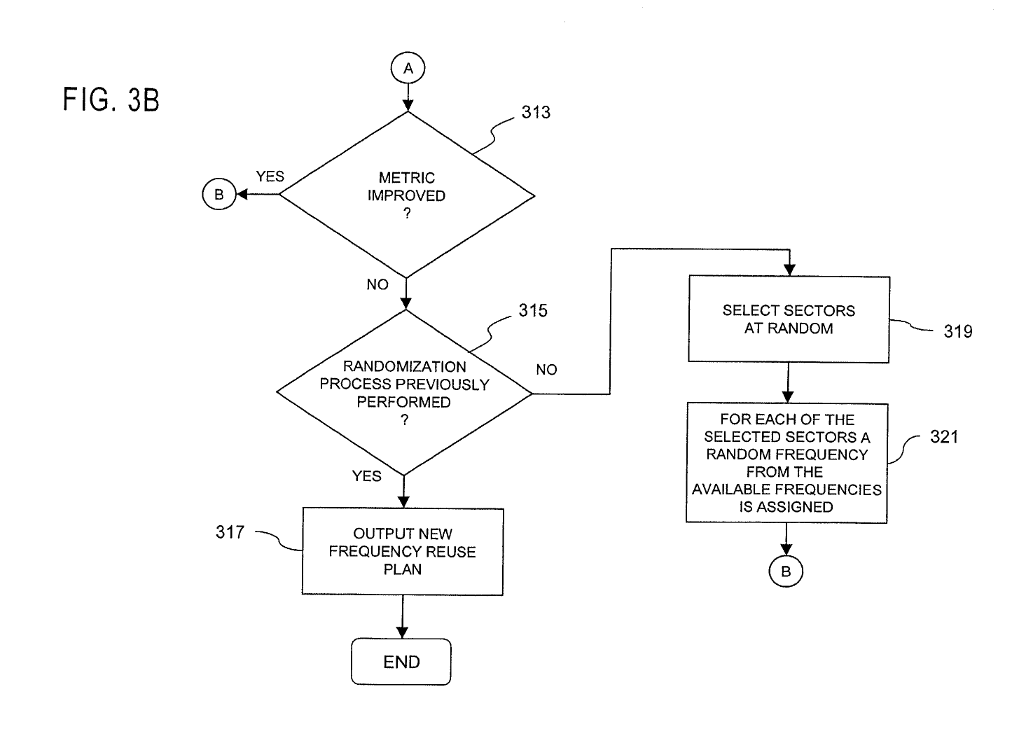

FIGS. 3A and 3B show a flowchart of a simulated annealing approach for frequency reuse planning, according to an embodiment of the present invention. A simulated annealing process is employed to generate a frequency reuse plan; this approach selects optimal or near optimal frequency reuse plans that maximizes some specified quality (or performance) metric. As shown in FIG. 2, the hubs (i.e., nodes) are conceptually laid out each with multiple sectors to cover a desired service area. Essentially, these hubs are overlaid onto a network map. A list of available frequencies is generated and subscriber and hub antenna patterns are obtained.

In this example, 16 hubs laid out on a square grid with a total of 64 sectors. Each sector can operate on one of the four frequencies (i.e., A, B, C, and D). Although the frequency reuse plan approach is described with four frequency sets, simulations have concluded that similar performance can be achieved with a frequency plan that employs only two frequencies using horizontal and vertical polarizations. With four frequency sets in this example, there are 4⁶⁴ possible configurations, wherein each configuration has a corresponding quality metric. The optimal configuration is the configuration with the highest quality metric; unfortunately, it is computationally impractical to evaluate each configuration. Consequently, the present invention provides a mechanism to effectively obtain an optimal or near optimal frequency reuse plan.

To initialize the annealing process of the present invention, each sector is assigned one of the available frequencies. The startup frequency assignments can be an existing plan, a manually draft plan, or a random frequency assignments if an initial plan is not available.

The map with the overlaid hubs is divided into specified map resolution cells (referred to herein as “pixels”). To optimize the network, the pixel sizes may be coarse; in an exemplary embodiment, 100×100 pixels per hub can be used. For the startup frequency plan, each pixel in turn is assigned a serving sector. The process of generating a new frequency reuse plan, according to an embodiment of the present invention, is now described.

In step 301, for each hub, the RF (radio frequency) powers of the serving sector and interfering sector are computed and the ratio of which forms the signal to noise ratio C/I. The powers may be calculated by using known RF propagation equations as well as the hub and subscriber antenna patterns; alternatively, the RF powers may be determined by inputting data from a RF propagation modeling tool that is based on the network map. In other words, for each subscriber or potential subscriber location, the total co-channel and adjacent channel interference can be computed or measured.

Next, the C/Is of all pixels are collected, and a performance metric is computed, per step 303. The present invention provides a number of performance metrics that have been developed to yield a frequency reuse plan with minimal co-channel interference. One metric focuses on the average C/I over all pixel C/I's, as expressed in the following equation:

M=Average(C/Iᵢ) Eq. (1).

Another performance metric involves a weighted average of the average C/I and a certain percentile C/I (e.g., 95^{th} percentile) of the pixel C/I's, according to Equation (2), below:

M=alpha*Average(C/Iᵢ)+(1−alpha)*[C/Iᵢ]_{95%}, Eq. (2)

where alpha is between 0 and 1. For example, this statistically based metric can be based on the C/I mean and a histogram's 99^{th} percentile C/I value with an alpha value of 0.5, as follows:

M=0.5*Average(C/Iᵢ)+0.5*[C/Iᵢ]_{99%}, Eq. (3)

This has the property of shifting the entire histogram of C/I's to the increasing C/I values.

Further, a metric, which is based upon the number of pixel C/I's exceeding a minimum C/Iₘᵢₙ, which may represent the minimum C/I value that is required to ensure a predetermined Bit Error Rate (BER) performance of the system. This metric directly maximizes the number of subscribers that meet the minimum C/I requirement for each modulation type, i.e., 25.8 dB for 64-QAM, 19.2 dB for 16-QAM, and 12 dB for QPSK. For example, this metric may be expressed as follows:

M=0.5*(% of subscriber with C/I>25.8 dB)+0.5*(% of subscribers with C/I>19.2 dB), Eq. (4)

This metric has the property of maximizing the number of valid installation locations. However, the metric does not increase the C/I beyond these minimum values.

Any of the above performance metric may be utilized. The selected performance metric is calculated for the initial frequency reuse plan. This calculated metric value serves as the baseline performance value. In an exemplary embodiment, the sectors are ordered, as in step 305, by average sector C/I, starting from smallest to the largest. For the smallest C/I sector, each of the available frequencies is temporarily assigned to the sector (per step 307). For each frequency assignment, the performance metric is computed, per step 309; this sector is assigned the frequency that yields the largest performance metric.

Steps 307 and 309 are performed for the next sector on the ordered list, in which all the available frequencies that optimize the sector's frequency assignment are evaluated. These steps 307 and 309 are repeated until all the sectors have been processed. In step 311, it is determined whether the last sector in the ordered list has a frequency assignment. Next, once all the sectors have been processed, the metric is examined to determine whether the metric has improved. If there has been an improvement, then steps 305-311 are repeated. This process continues until the performance metric yields no further improvements; that is, until the metric stabilizes.

Upon determining that the metric is no longer improving, a randomization process is performed. That is, to ensure that optimization process (steps 305-311) has not yielded a local maximum, a predetermined number of the sectors are randomly selected. The randomization process can be performed any number of times; according to an exemplary embodiment, this process is performed once. Accordingly, in step 315, it is determined whether the randomization process has been previously performed. If the randomization process has not been previously performed, the sectors are selected at random, per step 319. In step 321, for each of the selected sectors, a random frequency from the available frequency list is assigned to the sector. The entire optimization process (steps 305-311) is then repeated.

The reprocessing of the randomized assignments serves as the “annealing” process of the optimization. The annealing process continues for a fixed number of loops or until the performance metric does not increase and the process has found an optimal point. Thus, in step 317, the new frequency reuse plan is output.

It is observed that the above frequency reuse planning assumes that the hubs can be deployed on a perfect grid (see FIG. 2). Additionally, the pathloss analysis does not take into account any building blockages. Accordingly, a more robust approach is to optimize the frequency reuse based on realistic deployments and either theoretical or measured pathloss values.

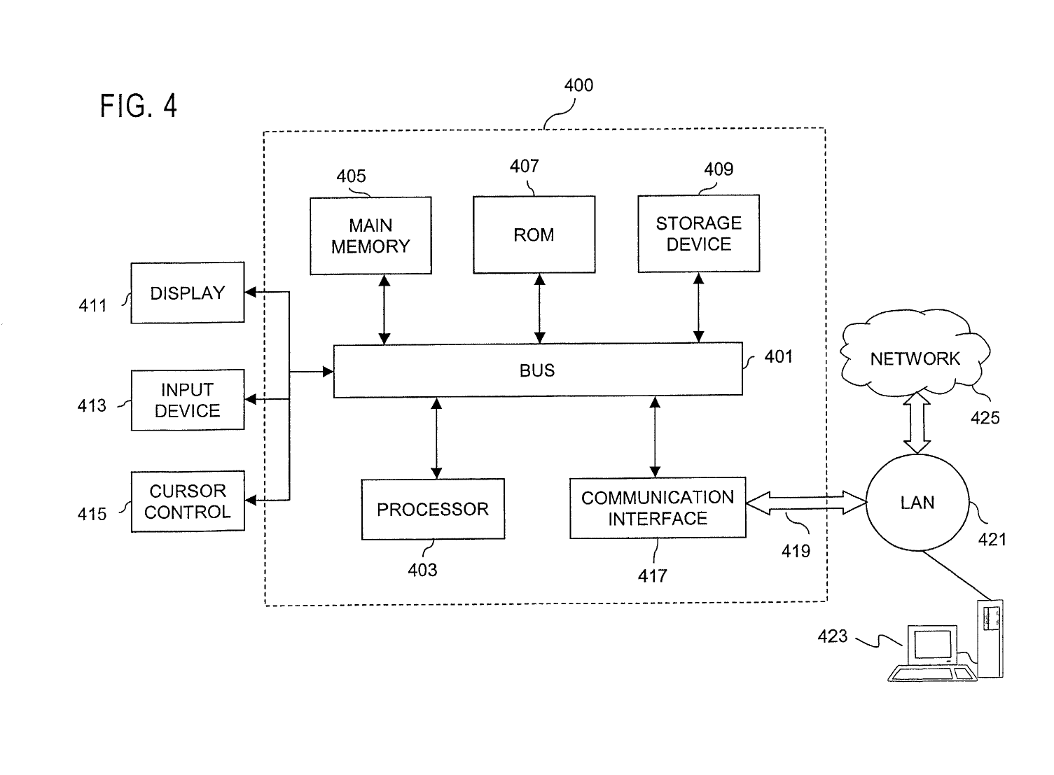

FIG. 4 shows a computer system 400 upon which an embodiment according to the present invention can be implemented. The computer system 400 includes a bus 401 or other communication mechanism for communicating information, and a processor 403 coupled to the bus 401 for processing information. The computer system 400 also includes main memory 405, such as a random access memory (RAM) or other dynamic storage device, coupled to the bus 401 for storing information and instructions to be executed by the processor 403. Main memory 405 can also be used for storing temporary variables or other intermediate information during execution of instructions to be executed by the processor 403. The computer system 400 further includes a read only memory (ROM) 407 or other static storage device coupled to the bus 401 for storing static information and instructions for the processor 403. A storage device 409, such as a magnetic disk or optical disk, is additionally coupled to the bus 401 for storing information and instructions.

The computer system 400 may be coupled via the bus 401 to a display 411, such as a cathode ray tube (CRT), liquid crystal display, active matrix display, or plasma display, for displaying information to a computer user. An input device 413, such as a keyboard including alphanumeric and other keys, is coupled to the bus 401 for communicating information and command selections to the processor 403. Another type of user input device is cursor control 415, such as a mouse, a trackball, or cursor direction keys for communicating direction information and command selections to the processor 403 and for controlling cursor movement on the display 411.

According to one embodiment of the invention, the frequency reuse plan approach of FIGS. 3A and 3B is provided by the computer system 400 in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the present invention. Thus, embodiments of the present invention are not limited to any specific combination of hardware circuitry and software.

The computer system 400 also includes a communication interface 417 coupled to bus 401. The communication interface 417 provides a two-way data communication coupling to a network link 419 connected to a local network 421. For example, the communication interface 417 may be a digital subscriber line (DSL) card or modem, an integrated services digital network (ISDN) card, a cable modem, or a telephone modem to provide a data communication connection to a corresponding type of telephone line. As another example, communication interface 417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 417 sends and receives electrical, electromagnetic, or optical signals that carry digital data streams representing various types of information. Further, the communication interface 417 can include peripheral interface devices, such as a Universal Serial Bus (USB) interface, a PCMCIA (Personal Computer Memory Card International Association) interface, etc.

The network link 419 typically provides data communication through one or more networks to other data devices. For example, the network link 419 may provide a connection through local network 421 to a host computer 423, which has connectivity to a network 425 (e.g. a wide area network (WAN) or the global packet data communication network now commonly referred to as the “Internet”) or to data equipment operated by service provider. The local network 421 and network 425 both use electrical, electromagnetic, or optical signals to convey information and instructions. The signals through the various networks and the signals on network link 419 and through communication interface 417, which communicate digital data with computer system 400, are exemplary forms of carrier waves bearing the information and instructions.

The computer system 400 can send messages and receive data, including program code, through the network(s), network link 419, and communication interface 417. In the Internet example, a server (not shown) might transmit requested code belonging an application program for implementing an embodiment of the present invention through the network 425, local network 421 and communication interface 417. The processor 404 may execute the transmitted code while being received and/or store the code in storage device 49, or other non-volatile storage for later execution. In this manner, computer system 400 may obtain application code in the form of a carrier wave.

The term “computer-readable medium” as used herein refers to any medium that participates in providing instructions to the processor 404 for execution. Such a medium may take many forms, including but not limited to non-volatile media, volatile media, and transmission media. Non-volatile media include, for example, optical or magnetic disks, such as storage device 409. Volatile media include dynamic memory, such as main memory 405. Transmission media include coaxial cables, copper wire and fiber optics, including the wires that comprise bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, the present invention provides a simulated annealing process to generate a frequency reuse plan. Using an initial frequency configuration (which may be arbitrary), a quality metric is computed. A frequency assignment that increases the metric the greatest is selected for each one of the sectors. This process continues until all the sectors have completed frequency reselection. The process is iterated until there are no more improvements to the metric. The selected configuration is then randomized to avoid finding a local metric peak. This process is repeated until the best configuration is generated. The present invention advantageously does not require perfectly placed hubs, and can use either theoretical pathloss values or measured pathloss values. Therefore, the present invention advantageously provides an optimal frequency reuse plan that minimizes co-channel interference.

While the present invention has been described in connection with a number of embodiments and implementations, the present invention is not so limited but covers various obvious modifications and equivalent arrangements, which fall within the purview of the appended claims.

What is claimed is:

1. A method for generating a frequency reuse plan for use in a radio communications system, the method comprising:
calculating a metric based upon an initial frequency reuse plan that specifies frequency assignments to a plurality of sectors, each of the plurality of sectors being associated with a signal level value;
ordering the plurality of sectors based upon the corresponding signal level values; and
iteratively modifying the frequency assignments to improve the metric according to the order of the plurality of sectors.

2. A method according to claim 1, wherein the signal level values are signal-to-noise ratio values, and the metric is based upon a percentage of an average of the signal-to-noise ratio values and a percentage of a signal-to-noise ratio value that is based upon a predetermined percentile.

3. A method according to claim 1, wherein the metric is based upon a predetermined threshold of signal-to-noise value.

4. A method according to claim 1, wherein the initial frequency reuse plan is based upon four frequency sets.

5. A method according to claim 1, further comprising:
sequentially assigning frequencies to the plurality of sectors according to the order.

6. A method according to claim 1, further comprising:
randomly selecting a portion of the plurality of sectors;
assigning frequencies to the selected sectors; and
recalculating the metric.

7. A computing system for generating a frequency reuse plan for use in a radio network, the computing system comprising:
means for calculating a metric based upon an initial frequency reuse plan that specifies frequency assignments to a plurality of sectors, each of the plurality of sectors being associated with a signal level value;
means for ordering the plurality of sectors based upon the corresponding signal level values; and
means for iteratively modifying the frequency assignments to improve the metric according to the order of the plurality of sectors.

8. A system according to claim 7, wherein the signal level values are signal-to-noise ratio values, and the metric is based upon a percentage of an average of the signal-to-noise ratio values and a percentage of a signal-to-noise ratio value that is based upon a predetermined percentile.

9. A system according to claim 7, wherein the metric is based upon a predetermined threshold of signal-to-noise value.

10. A system according to claim 7, wherein the initial frequency reuse plan is based upon four frequency sets.

11. A system according to claim 7, further comprising:
means for sequentially assigning frequencies to the plurality of sectors according to the order.

12. A system according to claim 7, further comprising:
means for randomly selecting a portion of the plurality of sectors;
means for assigning frequencies to the selected sectors; and
means for recalculating the metric.

13. A computer-readable medium carrying one or more sequences of one or more instructions for generating a frequency reuse plan for use in a radio communications system, when executed by one or more processors, cause the one or more processors to perform the steps of:
calculating a metric based upon an initial frequency reuse plan that specifies frequency assignments to a plurality of sectors, each of the plurality of sectors being associated with a signal level value;
ordering the plurality of sectors based upon the corresponding signal level values; and
iteratively modifying the frequency assignments to improve the metric according to the order of the plurality of sectors.

14. A computer-readable medium according to claim 13, wherein the signal level values are signal-to-noise ratio values, and the metric is based upon a percentage of an average of the signal-to-noise ratio values and a percentage of a signal-to-noise ratio value that is based upon a predetermined percentile.

15. A computer-readable medium according to claim 13, wherein the metric is based upon a predetermined threshold of signal-to-noise value.

16. A computer-readable medium according to claim 13, wherein the initial frequency reuse plan is based upon four frequency sets.

17. A method according to claim 13, wherein the one or more processors further perform the step of:
sequentially assigning frequencies to the plurality of sectors according to the order.

18. A method according to claim 13, wherein the one or more processors further perform the steps of:
randomly selecting a portion of the plurality of sectors;
assigning frequencies to the selected sectors; and
recalculating the metric.

19. A signal for use in a radio communications system, the signal comprising:
a frequency assigned according to a frequency reuse plan, wherein the frequency reuse plan is generated based upon a simulated annealing process that includes,
calculating a metric based upon an initial frequency reuse plan that specifies frequency assignments to a plurality of sectors, each of the plurality of sectors being associated with a signal level value;
ordering the plurality of sectors based upon the corresponding signal level values; and
iteratively modifying the frequency assignments to improve the metric according to the order of the plurality of sectors.

20. A signal according to claim 19, wherein the signal level values are signal-to-noise ratio values, and the metric is based upon a percentage of an average of the signal-to-noise ratio values and a percentage of a signal-to-noise ratio value that is based upon a predetermined percentile.

21. A signal according to claim 19, wherein the metric is based upon a predetermined threshold of signal-to-noise value.

22. A signal according to claim 19, wherein the initial frequency reuse plan is based upon four frequency sets.

23. A signal according to claim 19, wherein the simulated annealing process further includes sequentially assigning frequencies to the plurality of sectors according to the order.

24. A method according to claim 19, wherein the simulated annealing process further includes:
randomly selecting a portion of the plurality of sectors;
assigning frequencies to the selected sectors; and
recalculating the metric.

25. A radio communications system comprising:
a first terminal operating at a first frequency that is based upon a frequency reuse plan; and
a second terminal operating at a second frequency that is based upon the frequency reuse plan, wherein the frequency reuse plan is generated by calculating a metric based upon an initial frequency reuse plan that specifies frequency assignments that include the first frequency and the second frequency, the metric being optimized according to a simulated annealing process.

26. A system according to claim 25, wherein the metric is based upon a percentage of an average of signal-to-noise ratio values associated with the first terminal and the second terminal and a percentage of a signal-to-noise ratio value that is based upon a predetermined percentile of a histogram associated with the signal-to-noise ratio values.

27. A system according to claim 25, wherein the metric is based upon whether each of the terminals has a signal-to-noise value that satisfies a predetermined threshold.

28. A terminal for communicating in a radio communications system, the terminal comprising:
a transceiver configured to receive a signal having a predetermined frequency that is based upon a frequency reuse plan; and
a modulator operating at the predetermined frequency, wherein the frequency reuse plan is generated by calculating a metric based upon an initial frequency reuse plan that specifies frequency assignments that include the predetermined frequency, the metric being optimized according to a simulated annealing process.

29. A terminal according to claim 28, wherein the metric is based upon a percentage of an average of signal-to-noise ratio values and a percentage of a signal-to-noise ratio value that is based upon a predetermined percentile of a histogram associated with the signal-to-noise ratio values.

30. A terminal according to claim 28, wherein the metric is based upon whether the terminal has a signal-to-noise value that satisfies a predetermined threshold.
